(19) United States
(12) Patent Application Publication
(10) Pub. No.: US 2018/0354240 A1
(43) Pub. Date: Dec. 13, 2018

(54) MULTILAYER FILMS SUITABLE FOR USE IN FORM, FILL, AND SEAL PROCESSES AND PACKAGES FORMED THEREBY

(71) Applicant: SABIC GLOBAL TECHNOLOGIES B.V., Bergen op Zoom (NL)

(72) Inventors: Tariq Syed, Riyadh (SA); Bart Albertus Hubertus Esschert van den, Geleen (NL)

(21) Appl. No.: 16/060,130

(22) PCT Filed: Nov. 11, 2016
(86) PCT No.: PCT/IB2016/057004

§ 371 Date: Jun. 7, 2018

Related U.S. Application Data
(60) Provisional application No. 62/264,466, filed on Dec. 8, 2015.

(51) Int. Cl. B32B 27/08; B32B 27/30

(52) U.S. Cl. CPC B32B 27/08; B32B 27/306; B32B 27/34; B32B 2307/31; B32B 2439/46

(57) ABSTRACT

A multilayer film includes: a first outer layer and a second outer layer; a first inner layer positioned between the first outer layer and the second outer layer and adjacent to the first outer layer; and a second inner layer positioned between the first inner layer and the second outer layer; wherein the first and second inner layers are formed of a polymer including a glass transition temperature less than or equal to about 150° C. and a melt temperature of at least about 47° C.; and wherein, upon sealing, the first outer layer, the second outer layer, the first inner layer and the second inner layer provide a sealed multilayer film including a hot tack strength of at least about O.IN as determined by ASTM F1921 (2012), method B (based on a 15 mm width strip of film). Also provided herein are methods of making the multilayer films and packages formed from the multilayer films.

### BACKGROUND

Form, fill, and seal (FFS) processes, for example vertical form, fill, and seal (VFFS) processes, have been used in the past to package various foods, beverages and other products. Such processes can include the use of a roll of thermoplastic polymer film being fed to a forming tube. As the center of the film approaches the forming tube, the edges of the film wrap around the tube and the film is pulled downward such that a vertical seam can be created on the edges of the film by a vertical heat sealing bar. The vertical seam, which can form the back seal of a package, is thus the bonded edges of the film as a result of melting the edges together, thereby creating a tube formed from the polymer. The packaging or bagging process then includes a horizontal bar or bars that seal the bottom edge of the tube so that the package can be filled. The sealing bar or bars then seal the package to create a top seal after the package is filled and remaining film can be cut off or removed.

Such processes provide packages including top seals, bottom seals, or both top and bottom seals that can include inadequate seal strength, contain wrinkles, tear easily, or can otherwise be lacking in aesthetic appearance or exhibit undesirable visual appeal.

There accordingly remains a need in the art for improved film materials that can be used to form improved packages. There further remains a need in the art for improved process of producing packages.

### BRIEF DESCRIPTION

In an embodiment, a multilayer film includes: a first outer layer and a second outer layer; a first inner layer positioned between the first outer layer and the second outer layer and adjacent to the first outer layer; and a second inner layer positioned between the first inner layer and the second outer layer; wherein the first and second inner layers are formed of a polymer including a glass transition temperature less than or equal to about 150° C. and a melt temperature of at least about 47° C.; and wherein, upon sealing, the first outer layer, the second outer layer, the first inner layer and the second inner layer provide a sealed multilayer film including a hot tack strength of at least about 0.1N as determined by ASTM F1921 (2012), method B (based on a 15 mm width strip of film).

In another embodiment, a package formed of a sealed multilayer film composition includes: a sealed multilayer film configured to hold contents in the package, the sealed multilayer film comprising: a first outer layer and a second outer layer; a first inner layer positioned between the first outer layer and the second outer layer and adjacent to the first outer layer; and a second inner layer positioned between the first inner layer and the second outer layer; wherein the first and second inner layers are formed of a polymer including a glass transition temperature not greater than about 150° C. and a melt temperature of at least about 47° C.; and wherein the first and second outer layers, the first inner layer and the second inner layer forming the sealed multilayer film has a hot tack strength of at least about 0.1N as determined by ASTM F1921 (2012), method B (based on a 15 mm width strip of film).

In still another embodiment, a method of forming a hot seal on a multilayer film, the method includes: introducing a multilayer film to an apparatus including a heating mechanism, wherein the multilayer film comprises a first outer layer and a second outer layer; a first inner layer positioned between the first outer layer and the second outer layer and adjacent to the first outer layer; and a second inner layer positioned between the first inner layer and the second outer layer; forming a hot seal on the multilayer film with the heating mechanism, the hot seal including a hot tack strength of at least about 0.1N as determined by ASTM F1921 (2012), method B (based on a 15 mm width strip of film); and cooling the hot sealed multilayer film to form a sealed multilayer film.

The above described and other features are exemplified by the following figures and detailed description.

### BRIEF DESCRIPTION OF THE DRAWINGS

The following figures are exemplary embodiments, wherein the like elements are numbered alike.

FIG. 1 illustrates a flow diagram suitable for use in a form, fill, and seal process as described herein.

FIG. 2 illustrates a front view of a die suitable for use herein.

FIG. 3 shows a side view of a die suitable for use herein.

FIG. 4 illustrates a side view of a die suitable for use in accordance with another embodiment herein.

FIG. 5 shows a side view of the die arrangement of FIG. 4.

### DETAILED DESCRIPTION

Provided herein are multilayer films and packages, and methods of forming the packages. In particular, multilayer films, packages, and processes suitable for use in form, fill, and seal processes are provided. The multilayer films can be used, for example, in apparatus and processes for vertical form, fill, and seal (VFFS) processes, apparatus and processes for horizontal form, fill, and seal (HFFS) processes, and dual web packaging. The packages can be configured to hold a wide variety of products, for example food products, cosmetics, soaps, pharmaceuticals, or a combination including at least one of the foregoing. The products can be in any form, for example solid, liquid, dispersion, emulsion, gel, or the like. The multilayer films, packages, and processes can provide improved sealing characteristics, improved aesthetic characteristics (e.g., less wrinkling or crinkling of the formed package), or both. Consequently, improved packaging for a variety of products, (e.g., foods or beverages) can be achieved.

The multilayer films include first and second outer layers; a first inner layer positioned adjacent to the first outer layer; and a second inner layer positioned adjacent to the first inner layer and the second outer layer. The first and second inner layers are formed of a polymer including a glass transition temperature (Tg) of less than or equal to about 150° C. and a melt temperature of at least about 47° C. In some embodiments, at least one of the first and second inner layers can include a Tg less than or equal to about 0° C. In some embodiments, at least one of the first and second inner layers includes a melt temperature of at least about 50° C. The inner layers can include a lower Tg and melt temperature than the outer layers. The outer layers of the multilayer film can be selected to provide desired mechanical, optical, barrier, or other properties. Without being bound by theory, use of the first and second inner layers including the specified Tg and melt temperature provide a multilayer film where the inner layers can readily laminate to the outer layers to provide optimal sealing properties.

Thus, upon sealing, the sealed first and second outer layers and first and second inner layers include a hot tack strength of at least about 0.1N as determined by ASTM F1921 (2012), method B (for example, on a 15 mm width strip of film). In some embodiments, upon sealing, the sealed first and second outer layers and first and second inner layers include a hot tack strength of at least about 0.15N as determined by ASTM F1921 (2012), method B (for example, on a 15 mm width strip of film). In still other embodiments, upon sealing, the sealed first and second outer layers and first and second inner layers include a hot tack strength of at least about 0.2N as determined by ASTM F1921 (2012), method B (for example, on a 15 mm width strip of film).

As stated above, the first and second inner layers include a Tg of less than or equal to about 150° C., for example about 150° C. to about −150° C. In some embodiments the Tg can be less than about 0° C., for example about 0° C. to about −150° C. In some embodiments the Tg can be about −20° C. to about −150° C. In some embodiments the Tg can be about −30° C. to about −125° C.

The first and second inner layer further include a melt temperature of greater than or equal to about 47° C., for example about 47° C. to about 280° C. In some embodiments the melt temperature can be about 50° C. to about 220° C. In some embodiments the melt temperature can be greater than or equal to about 100° C., for example about 100° C. to about 220° C. In some embodiments, the melt temperature can be about 130° C. to about 180° C.

In still other embodiments, the first and second inner layer can include a Tg of about 150° C. to about −150° C. and a melt temperature of about 47° C. to about 280° C. In some embodiments the Tg is about 0° C. to about −150° C. and the melt temperature is about 50° C. to about 220° C. In some embodiments the Tg is about −20° C. to about −150° C. and the melt temperature is about 100° C. to about 220° C. In some embodiments the Tg is about −30° C. to about −125° C. and the melt temperature is about 130° C. to about 180° C.

The polymer(s) used to form the first and second inner layers can be selected based on the desired Tg and melt temperatures, as well as other properties, for example optical clarity, toughness, chemical resistance, elasticity, and the like. The first and second inner layers can be formed of the same or different polymer, or the same or different combination of polymers. The polymer(s) can include, but are not limited to, low density polyethylene (PE-LD or LDPE), linear low density polyethylene (LLDPE), very low density linear polyethylene (vLLDPE), polyvinylidene fluoride (PVDF), ethylene-vinyl acetate (EVA), ethylene-vinyl alcohol (EVOH), polypropylene (PP), polyvinyl chloride (PVC), polyamide (PA), polyethylene terephthalate (PET), polybutylene terephthalate (PBT), polycarbonate (PC), an ionomer of any of the foregoing, or a combination including at least one of the foregoing. In some embodiments, suitable first and second inner layers include, but are not limited to EVA, LLDPE, vLLDPE, PVDF, or a combination including at least one of the foregoing, due to the excellent sealing performance characteristics of such polymers. Both of LLDPE and vLLDPE are also known in the art as plastomers. A combination including at two polymers can be used in the first inner layer, the second inner layer, or both. In some embodiments a single polymer is used in the first inner layer, the second inner layer, or both.

In some embodiments, EVA including a Tg/melt temperature of about −20° C. to about −60° C./about 47° C. to about 100° C. can be used. For example, at least one of the first and second inner layers can include ethylene-vinyl acetate (EVA) including a Tg of less than about −25° C. and a melt temperature of at least about 47° C. While EVA has a low melt temperature, EVA can provide desirable sealing properties.

For example and depending on the product to be formed, suitable inner layers can include one or both inner layers being formed of low Tg/high melt temperature polymers. For example, in some embodiments, LDPE, LLDPE, or vLLDPE including a Tg/melt temperature of about −145° C. to about −90° C./about 105 to about 280° C. can be used. In some embodiments LDPE, LLDPE, or vLLDPE including a Tg/melt temperature of about −130° C. to about −120° C./greater than about 130° C., or about 130° C. to about 280° C. can be used. In some embodiments, at least one of the first and second inner layers in the multilayer film can be formed from an LDPE, LLDPE, or vLLDPE including a Tg of about −125° C. and a melt temperature of at least about 130° C. Alternatively, in some embodiments, PVDF including a Tg/melt temperature of about −50° C. to about −20° C./about 165° C. to about 185° C. can be used. In some embodiments PVDF including a Tg/melt temperature of about −25° C. to about −45° C./about 165° C. to about 180° C. can be used. In some embodiments, at least one of the first and second inner layers can include PVDF including a Tg of about −40° C. and a melt temperature of at least about 171° C.

The inner and outer layers can include materials selected to fulfill the desired optical, mechanical, barrier, toughness, sealing, hot tack, or the like properties. As mentioned above, the inner layers are selected to be laminated on the outer layers to provide optimal sealing properties, whereas the outer layers can be selected to provide desired optical, mechanical, or barrier properties, or the like. The selection of the inner layers in combination with the outer layers can be varied depending on the desired properties of the package to be formed, to attain certain processing conditions (e.g., faster processing, lower temperature processing, or the like), or both.

The first and second outer layers can be formed of the same or different polymers. Exemplary outer polymers include LDPE, LLDPE, high density polyethylene (PE-HD or HDPE), PVDF, EVA, EVOH, PP, PVC, PC, PA, PET, PBT, an ionomer of any of the foregoing, or a combination including of any of the foregoing. In some embodiments the first and second outer layers comprise LDPE, HDPE, PP, PVC, PC, PA, PET, PBT, or a combination comprising at least one of the foregoing. A combination of polymers can be used to form the first outer layer, the second outer layer, or both. In some embodiments a single polymer can be used to form the first outer layer, the second outer layer, or both.

In some embodiments, the first outer layer can include HDPE, LDPE, PA, PP, EVA, PET, or a combination including at least one of the foregoing; the second outer layer can include HDPE, LDPE, LLDPE, PP, EVA, PET or a combination including at least one of the foregoing; the first inner layer adjacent to the first outer layer can include LLDPE, vLLDPE, or EVA; and the second inner layer can include LDPE, LLDPE, EVA, or a combination including at least one of the foregoing. Upon sealing, such a multilayer film arrangement can provide a hot tack seal strength of at least about 0.1N as determined by ASTM F1921 (2012), method B (for example, on a 15 mm width strip of film).

Methods of forming a hot seal on a multilayer film including the first and second outer layers and the first and second inner layers as described above include introducing the multilayer film to an apparatus including a heating mechanism; sealing the multilayer film with the heating mechanism to form a hot sealed multilayer film such that the hot seal formed on the multilayer film has a hot tack strength of at least about 0.1N as determined by ASTM F1921 (2012), method B (for example, on a 15 mm width strip of film); and cooling the hot sealed multilayer film to form a sealed multilayer film.

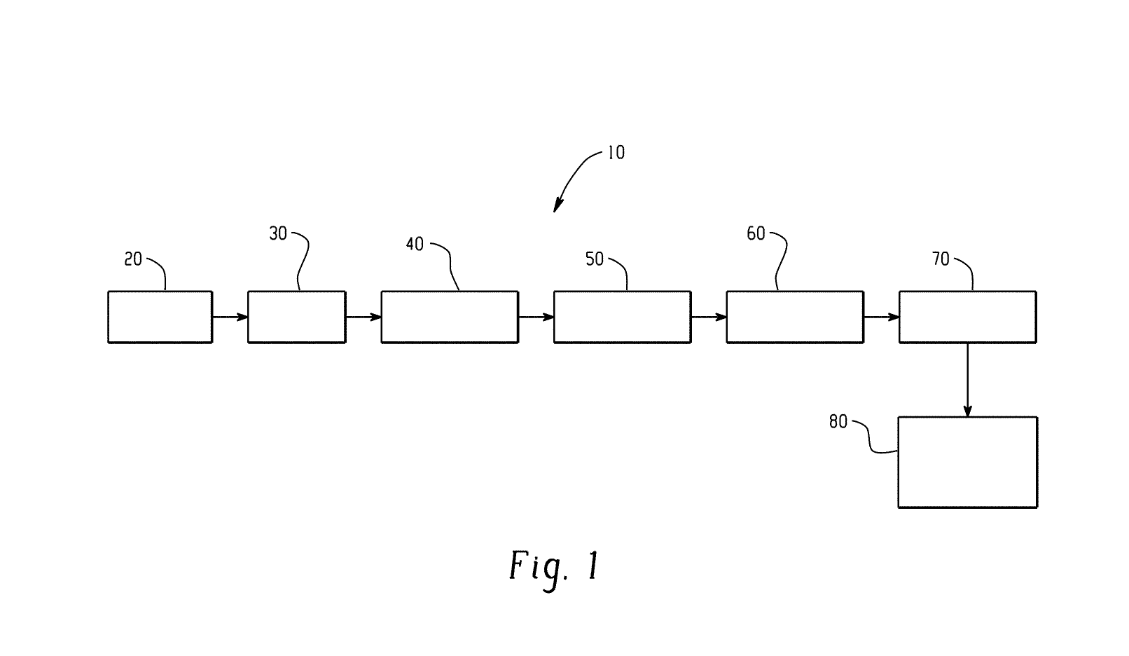

Referring now to FIG. 1, a flow diagram for a packaging process is illustrated. Such processes can include, for example, a vertical form, fill, and seal (VFFS) process. Process 10 includes providing multilayer film 20 (such as film 133 as discussed below) to forming tube 30 such that the edges of multilayer film 20 winds around forming tube 30 and can in a VFFS process, be pulled downward, thereby forming a tube. Formation of back seal step 40 can include a vertical heat sealing bar or mechanism that seals the edges of multilayer film 20 wrapped around forming tube 30. The formed tube can then be pulled downward and a heat sealing die as discussed herein is used for formation of bottom seal 50, thereby forming an open package. Filling of package 60 includes filling the package with the desired food, liquid or other product, followed by formation of top seal 70 and subsequent processing and completed packaging 80. Process 10 can be a batch or a continuous process.

It will be appreciated that use of the multilayer films provided herein are not limited to VFFS. As mentioned above, alternative apparatus and processes can be employed such that horizontal form, fill, and seal (HFFS) processes or dual web packaging can be used in conjunction with the multilayer films.

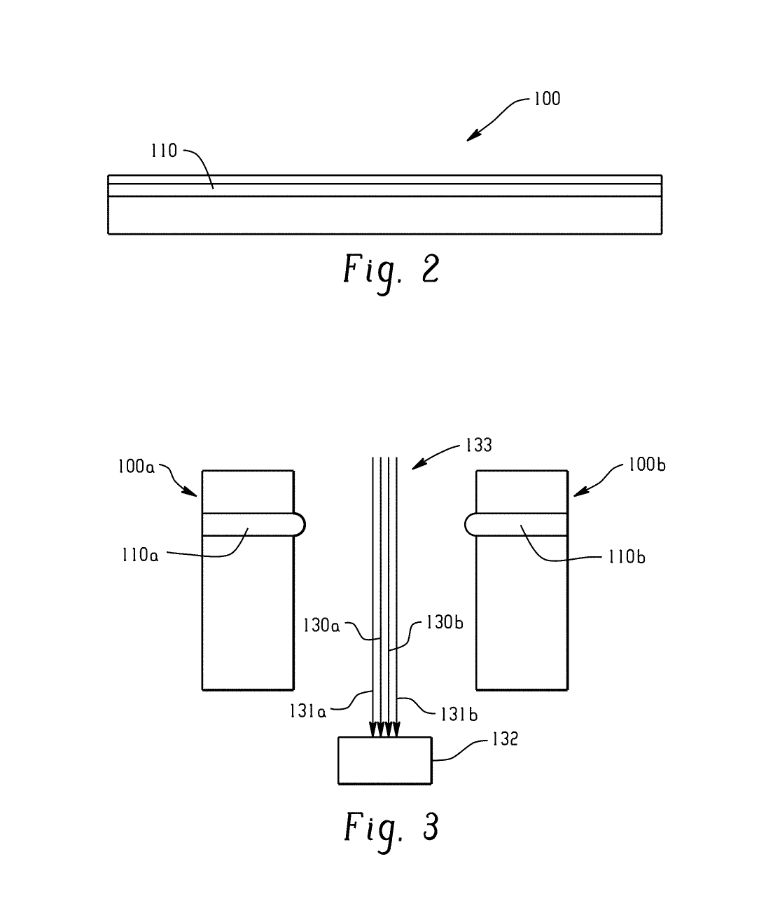

Reference now is had to FIG. 2 which illustrates a front view of die sealing bar 100. Die 100 includes a heating mechanism that includes heat sealing lip 110. Heating mechanism of die sealing bar 100 includes heat sealing lip 110 configured to seal the tube of film formed in the process to provide bottom and top seals as discussed above. Heat sealing lip 110 can be of the type that is currently commercially available.

As can be seen in more detail in FIG. 3, in operation, die 100 can include two die halves, 100a and 100b, to be used to clamp or seal multilayer film 133 by closing the dies inwardly around multilayer film 133 within a temperature in the range of about 40 to about 300° C. The temperature ranges that can be used in the process will depend on various factors such as the polymer(s) used, desired seal strength, or other processing conditions. For example, the seal that is formed and the strength of the seal will in part depend on the melting temperature of the polymer(s) being used and processing conditions employed. If the process temperature is too low, the seal does not adequately form. If the process temperature used is too high, cooling can take too long, and the seal can still be too hot to withstand the forces that occur during filling. Consequently, the seal can be inadequate if the temperatures are too high. Hot sealing lips 110a and 110b contact multilayer film 133 and form the various top and bottom seals by sealing inner layers 130a, 130b to one another and to outer layers 131a, 131b. The seals formed thereby can be a bottom seal of a package, or a top seal of a package, or both. In a continuous process, the formed seal can be a top seal of a filled package and a bottom seal of the next package in sequence. The packages can then be subsequently separated.

Following formation of the seal, the dies are retracted and the formed open package can be filled. The dies, which can be movable in the process line, can then again be used to provide a top seal at a designated or predetermined space on the open package. Optionally, in a continuous process, the sealing dies can be used to simultaneously provide the top seal of the package and the bottom seal of the next package. Cooling of the seals formed in this embodiment can include ambient cooling. In this manner, sealed packages 132 including improved sealing characteristics and aesthetic characteristics (e.g., less wrinkling or crinkling of the package) can be formed. In some embodiments, packages 132 can be formed in a continuous manner.

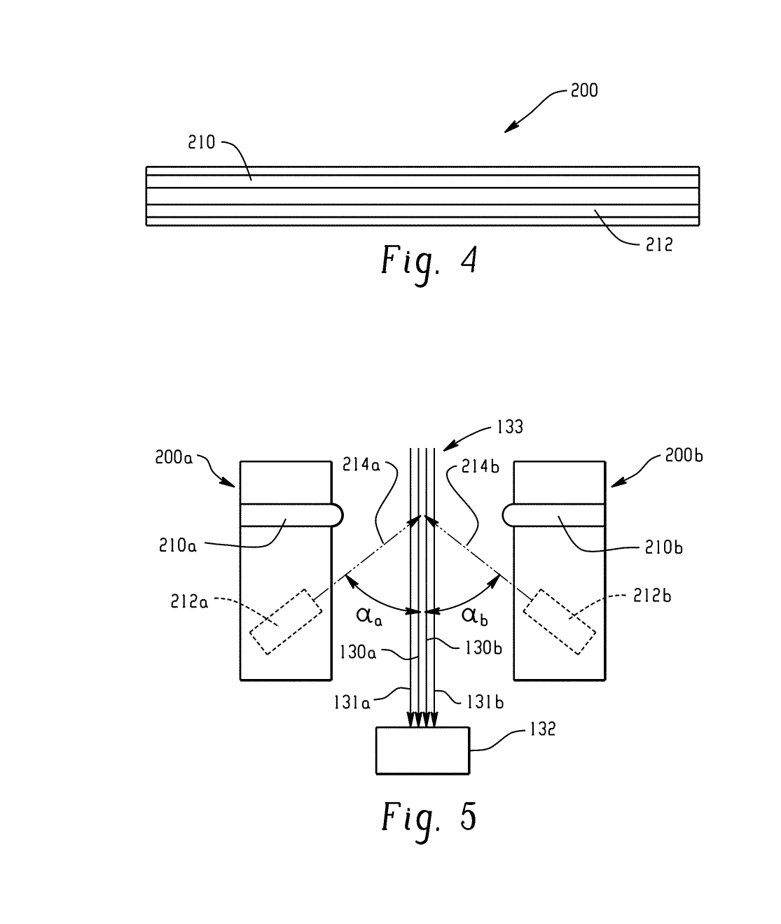

Reference is now had to FIG. 4 which illustrates a front view of die sealing bar 200. Die 200 includes a heating mechanism that includes heat sealing lip 210 and a cooling mechanism that includes gas ducts 212 arranged to provide gas cooling (e.g., gas jet(s), 214a, 214b, or 214a and 214b shown for example in FIG. 5) to a film immediately following heat sealing by heat sealing lip 210. Heat sealing lip 210 can be of the type that is currently commercially available. The gas of the gas jets can be air (e.g., compressed air), nitrogen, argon, or an inert gas, i.e., a gas which does not undergo chemical reactions under a set of given conditions) or a combination including at least one of the foregoing. In some arrangements, gas jets (e.g., air jets) can be used based on convenience and cost.

In some embodiments, a single die 200 can be used in a process to form a seal. In such a case, the die could be pressed against a surface with film 133 therebetween to create the desired hot seal and cooling. The angle of the gas jet (e.g., air jet) can be selected to contact a sufficient amount of the hot seal just formed to provide adequate cooling and sealing. In some embodiments, the gas jet (e.g., air jet) is arranged to contact the entire hot seal to be cooled. If the angle of the gas jets (e.g., air jet(s)) is too low or too high, the gas jet(s) (e.g., air jet(s)) could miss contacting the desired hot seal or only contact a portion of the desired hot seal such that an inadequate seal or a seal otherwise lacking in aesthetic appeal is formed thereby.

As can be seen in more detail in FIG. 5, in operation, die 200 can include for example two die halves, 200a and 200b, to be used to clamp or seal film 133 by closing the dies inwardly around film 133 within a temperature in the range of about 40 to about 300° C. to seal inner layers 130a, 130b to outer layers 131a, 131b. The temperature ranges that can be used in the process will depend on factors such as the polymer(s) used, the type of package to be formed (based on the intended use, cost, or other considerations), or process conditions, for example desired speed of throughput. For example, the seal that is formed and the strength of the seal will in part depend on the melting temperature of the polymer(s) being used. If the temperature is too low, the seal does not adequately form. If the temperature used is too high, cooling can take too long, and the seal can still be too hot to withstand the forces that occur during filling embodiment of the process. Consequently, the seal can be inadequate if the temperatures are too high. Given the teachings herein, one skilled in the art can determine the operating temperature of the sealing bar(s) so that a sufficiently high enough temperature is used to adequately melt the film in a desirably short time as to lead to a higher production speed and improved efficiency. This can further depend, for example, on the thickness and composition of the film. In some embodiments, the heating mechanism is configured to provide the hot seal to the multilayer film within a temperature range of about 100 to about 250° C. More specifically, hot sealing lips 210a and 210b contact film 133 to form the seal, e.g., a bottom seal of a package or a top seal of a package. In a continuous process, the formed seal can be a top seal of a filled package and a bottom seal of the next package in sequence. The packages can then be subsequently separated.

Following formation of the seal, the dies are retracted. As the dies are retracted, gas (e.g., air) ducts 212a and 212b are arranged to immediately (e.g., within about a few milliseconds, i.e., almost instantaneously) provide gas jets (e.g., air jets) 214a and 214b arranged to contact the seal that has just been formed and cool the seal to a desired temperature. For example, cooling by the gas jet(s) can be provided within less than about 5 milliseconds; in some cases, less than about 4 milliseconds; and in yet other instances, less than about 3 milliseconds. In still other embodiments, cooling by the gas jet(s) can be provided within less than about 2 milliseconds; and in some cases, less than about 1 millisecond. Gas jet(s) (e.g., air jet(s)) 214a, 214b or 214a and 214b are arranged to contact the formed seal on film 130, 131 at an appropriate angle(s) such as αₐ, α_{b} or αₐ and α_{b}. αₐ and α_{b} can be any angle arranged to provide desired cooling to the seal on film 133. αₐ, α_{b} or αₐ and α_{b} can be for example 0 to about 60°. In other embodiments, αₐ, α_{b} or αₐ and α_{b} can be about 15 to about 60°. The angle(s) of the gas jet(s) (e.g., air jet(s)) can be selected to contact a sufficient amount of the hot seal just formed to provide adequate cooling and sealing. In some embodiments, the gas jet(s) (e.g., air jet(s)) will be arranged to contact the entire hot seal to be cooled. If the angle of the gas jet(s) (e.g., air jet(s)) is too low or too high, the gas jet(s) (e.g., air jet(s)) could miss contacting the desired hot seal or only contact a portion of the desired hot seal such that an inadequate seal or a seal otherwise lacking in aesthetic appeal is formed thereby. The desired pressure(s) and temperature(s) can be determined based on the type of polymers to be sealed, the strength of the desired seal to be formed, the type of package to be formed, and the intended use of the package. In some embodiments, the cooling mechanisms and gas (e.g., air) ducts 212a and 212b are arranged to respectively provide gas jets (e.g., air jets) 214a and 214b within a pressure range and a temperature range of about 0 to about 40° C. such that the hot seal on the multilayer film can be quenched within about 0.1 to about 0.5 seconds. In this manner, sealed packages 132 including improved sealing characteristics and aesthetic characteristics (e.g., less wrinkling or crinkling of the package) can be formed. In some embodiments, packages 132 can be formed in a continuous manner.

The dies can be arranged such that as the hot sealing lip(s) are retracted, the cooling mechanism is activated to provide the gas jet(s) (e.g., air jet(s)) and thus provide cooling at the seal. The hot sealing lips are therefore not cooled by the cooling mechanism as the initiation of the retraction of the hot sealing lips is arranged to initiate the cooling process. The seal time can vary depending on the conditions and set up of the seals to be formed and materials to be used. The cooling mechanism can allow a cooling time at least 40% less than conventional cooling time. For example, the cooling time using the cooling mechanisms herein can allow hot seals formed of the same materials and conditions to be cooled to ambient temperature in at least 40% less time than the time required to cool a hot seal simply using ambient conditions for cooling. Thus, the cooling mechanism provided herein allows for improved seals as well as a faster process. In some embodiments, the cooling mechanism can allow a cooling time of at least about 50% less than conventional cooling time. In yet other embodiments, the cooling mechanism can allow a cooling time of at least about 60% less than conventional cooling time.

In some instances, the seal strength can be approximately the same or better as when conventional cooling is used. Because the cooling rate as provided herein can be enhanced, however, the seal strength can reach its desired strength sooner than with conventional cooling. Consequently, overall production times can be faster and efficiency thereby improved. In addition, with the use of more effective cooling as provided herein, sealing time can also be reduced. For example, the sealing bars can be set at a higher temperature so the seal is formed faster (i.e., a higher temperature difference, dT, and hence a higher heat flow). In this case, the seal will include a higher temperature after opening the bars, but due to the forced cooling the heat flow during cooling also is higher.

Details of the sealing die arrangements and processes shown in FIGS. 4 and 5 can be found in commonly owned and copending application Ser. No. 62/264,452, Attorney Docket No. (P080163US) and entitled “Apparatus And Methods Of Use For Form, Fill And Sealing Dies And Packages Formed Thereby” and filed on even date herewith, the entire contents of which are incorporated herein by reference.

The multilayer films, packages, and methods are further illustrated by the following Embodiments.

### Embodiment 1

a multilayer film includes: a first outer layer and a second outer layer; a first inner layer positioned between the first outer layer and the second outer layer and adjacent to the first outer layer; and a second inner layer positioned between the first inner layer and the second outer layer; wherein the first and second inner layers are formed of a polymer including a glass transition temperature less than or equal to about 150° C. and a melt temperature of at least about 47° C.; and wherein, upon sealing, the first outer layer, the second outer layer, the first inner layer and the second inner layer provide a sealed multilayer film including a hot tack strength of at least about 0.1N as determined by ASTM F1921 (2012), method B (based on a 15 mm width strip of film).

### Embodiment 2

The multilayer film of Embodiment 1, wherein the first and second inner layers include a low density polyethylene, linear low density polyethylene, very low density linear polyethylene, polyvinylidene fluoride, ethylene-vinyl acetate, ethylene-vinyl alcohol, polypropylene, polyvinyl chloride, polyamide, polyethylene terephthalate, polybutylene terephthalate, polycarbonate, an ionomer of any of the foregoing, or a combination comprising at least one of the foregoing.

### Embodiment 3

The multilayer film of Embodiments 1 or 2, wherein the first and second inner layers comprise a low density polyethylene, linear low density polyethylene, very low density linear polyethylene, polyvinylidene fluoride, ethylene-vinyl acetate, or a combination comprising at least one of the foregoing.

### Embodiment 4

The multilayer film of any of Embodiments 1-3, wherein at least one of the first and second inner layers comprises a Tg less than or equal to about 0° C.

### Embodiment 5

The multilayer film of any of Embodiments 1-5, wherein at least one of the first and second inner layers comprises a melt temperature of at least about 50° C.

### Embodiment 6

The multilayer film of any of Embodiments 1-5, wherein at least one of the first and second inner layers comprises a Tg of about 0° C. to about −150° C. and a melt temperature of about 50° C. to about 220° C.

### Embodiment 7

The multilayer film of any of Embodiments 1-6, wherein at least one of the first and second inner layers comprises a Tg of about −20° C. to about −150° C. and a melt temperature of about 100° C. to about 220° C.

### Embodiment 8

The multilayer film of any of claims 1-6, wherein at least one of the first and second inner layers comprises a Tg of about −30° C. to about −125° C. and a melt temperature of about 130° C. to about 180° C.

### Embodiment 9

The multilayer film of any of Embodiments 1-7, wherein the multilayer film includes a sealed multilayer film including a hot tack strength of at least about 0.15N as determined by ASTM F1921 (2012), method B (based on a 15 mm width strip of film).

### Embodiment 10

The multilayer film of Embodiment 8, wherein the multilayer film includes a sealed multilayer film including a hot tack strength of at least about 0.2N as determined by ASTM F1921 (2012), method B (for example, on a 15 mm width strip of film).

### Embodiment 11

The multilayer film of any of Embodiments 1-10, wherein at least one of the first and second outer layers a low density polyethylene, linear low density polyethylene, high density polyethylene, polyvinylidene fluoride, ethylene-vinyl acetate, ethylene-vinyl alcohol, polypropylene, polyvinyl chloride, polyamide, polyethylene terephthalate, polybutylene terephthalate, polycarbonate, an ionomer of any of the foregoing, or a combination comprising at least one of the foregoing.

### Embodiment 12

The multilayer film of Embodiment 11, wherein the first and second outer layers comprise a low density polyethylene, high density polyethylene, ethylene-vinyl alcohol, polypropylene, polyvinyl chloride, polyamide, polyethylene terephthalate, polybutylene terephthalate, polycarbonate, or a combination comprising at least one of the foregoing.

### Embodiment 13

A package formed of a sealed multilayer film composition, comprising: a sealed multilayer film configured to hold contents in the package, the sealed multilayer film comprising: a first outer layer and a second outer layer; a first inner layer positioned between the first outer layer and the second outer layer and adjacent to the first outer layer; and a second inner layer positioned between the first inner layer and the second outer layer; wherein the first and second inner layers are formed of a polymer including a glass transition temperature not greater than about 150° C. and a melt temperature of at least about 47° C.; and wherein the first and second outer layers, the first inner layer and the second inner layer forming the sealed multilayer film has a hot tack strength of at least about 0.1N as determined by ASTM F1921 (2012), method B (based on a 15 mm width strip of film).

### Embodiment 14

A method of forming a hot seal on a multilayer film, the method including: introducing a multilayer film to an apparatus including a heating mechanism, wherein the multilayer film comprises a first outer layer and a second outer layer; a first inner layer positioned between the first outer layer and the second outer layer and adjacent to the first outer layer; and a second inner layer positioned between the first inner layer and the second outer layer; forming a hot seal on the multilayer film with the heating mechanism, the hot seal including a hot tack strength of at least about 0.1N as determined by ASTM F1921 (2012), method B (based on a 15 mm width strip of film); and cooling the hot sealed multilayer film to form a sealed multilayer film.

### Embodiment 15

The method of Embodiment 14, wherein the cooling is provided by a gas jet to cool the hot sealed multilayer film to a desired temperature.

### Embodiment 16

The method of Embodiment 15, wherein the gas jet includes a plurality of gas jets.

### Embodiment 17

The method of Embodiments 15 or 16, wherein the gas jet is provided within less than about 5 milliseconds.

### Embodiment 18

The method of any of Embodiments 15-17, wherein the gas jet is arranged to contact the hot sealed multilayer film an appropriate angle

### Embodiment 19

The method of Embodiment 18, wherein the angle is 0 to about 60°.

### Embodiment 20

The method of any of Embodiments 14-19, wherein the first and second inner layers are formed of a material(s) including a Tg less than or equal to about 150° C. and a melt temperature of at least about 47° C.

### Embodiment 21

The method of any of Embodiments 14-20, wherein the polymer of at least one of the first and second inner layers comprises a low density polyethylene, linear low density polyethylene, very low density linear polyethylene, polyvinylidene fluoride, ethylene-vinyl acetate, ethylene-vinyl alcohol, polypropylene, polyvinyl chloride, polyamide, polyethylene terephthalate, polybutylene terephthalate, polycarbonate, an ionomer of any of the foregoing, or a combination comprising at least one of the foregoing.

### Embodiment 22

The method of any of Embodiments 14-21, wherein the multilayer film includes a sealed multilayer film including a hot tack strength of at least about 0.15N as determined by ASTM F1921 (2012), method B (for example, on a 15 mm width strip of film).

### Embodiment 23

The method of any of Embodiments 14-22, wherein the multilayer film includes a sealed multilayer film including a hot tack strength of at least about 0.2N as determined by ASTM F1921 (2012), method B (for example, on a 15 mm width strip of film).

### Embodiment 24

The method of any of Embodiments 14-23, wherein at least one of the first and second outer layers include wherein at least one of the first and second outer layers comprises a low density polyethylene, linear low density polyethylene, high density polyethylene, polyvinylidene fluoride, ethylene-vinyl acetate, ethylene-vinyl alcohol, polypropylene, polyvinyl chloride, polyamide, polyethylene terephthalate, polybutylene terephthalate, polycarbonate, an ionomer of any of the foregoing, or a combination comprising at least one of the foregoing.

### Embodiment 25

A package formed by the method of any of Embodiments 14-24.

As used herein, “hot tack strength” refers to the peeling force required to separate films when the sealing area is not cooled to ambient conditions. The hot-tack strength is thus the seal force of the film when the seal still is warm, prior to cooling. An exemplary device for measuring hot tack strength is J&B Hot Tack Tester, Model 4000, commercially available from Swiss Management NV. Hot tack is heat seal strength immediately after sealing and before cooling and reaching a maximum seal strength The seals formed using the disclosed apparatus and methods provided can allow for hot tack strength of at least about 0.1N as determined by ASTM F1921 (2012), method B (based on a 15 mm width strip of film).

As used herein, “hot tack force” refers to the peeling force required when sealing area is not completely cooled.

As used herein, a “hot seal” on a multilayer film refers to a seal that has been formed from a heating mechanism, but prior to cooling the hot seal. “Hot seal(s)” on a multilayer film can thus include a hot tack force of at least about 0.1N as determined by ASTM F1921 (2012), method B (for example, on a 15 mm width strip of film). A “hot sealed multilayer film” thus can thus include a hot tack force of at least about 0.1N/15 mm width strip of film as determined by ASTM F1921 (2012), method B (based on a 15 mm width strip of film).

As used herein, a “sealed multilayer film” refers to a multilayer film subsequent to cooling. The sealed multilayer film can include being sealed at a bottom portion of a package (for example prior to filling of the package). In addition, a sealed multilayer film can include a film sealed at both a bottom and a top portion of a package (for example subsequent to filling of the package). A “sealed multilayer film” thus can thus include a hot tack strength of at least about 0.1N as determined by ASTM F1921 (2012), method B (for example, on a 15 mm width strip of film).

In general, the methods and articles described herein can comprise, consist of, or consist essentially of, any appropriate steps or components herein disclosed. The methods and articles can additionally, or alternatively, be formulated so as to be devoid, or substantially free, of any components, materials, ingredients, adjuvants or species that are not necessary to the achievement of the function and/or objectives of the present methods and articles.

All ranges disclosed herein are inclusive of the endpoints, and the endpoints are independently combinable with each other (e.g., ranges of “up to 25 wt. %, or, for example, 5 wt. % to 20 wt. %,” is inclusive of the endpoints and all intermediate values of the ranges of “5 wt. % to 25 wt. %,” etc.). The modifier “about” used in connection with a quantity is inclusive of the stated value (e.g., “about 25 to about 50 wt %” is a disclosure of “25 to about 50 wt. %) and has the meaning dictated by the context (e.g., includes the degree of error associated with measurement of the particular quantity). “Combination” is inclusive of blends, mixtures, alloys, reaction products, or the like. Furthermore, the terms “first,” “second,” or the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. “Or” means “and/or.” The suffix “(s)” as used herein is intended to include both the singular and the plural of the term that it modifies, thereby including one or more of that term (e.g., the film(s) includes one or more films). Reference throughout the specification to “some embodiments”, “another embodiment”, “an embodiment,” and so forth, means that a particular element (e.g., feature, structure, and/or characteristic) described in connection with the embodiment is included in at least one embodiment described herein, and may or may not be present in other embodiments. In addition, it is to be understood that the described elements can be combined in any suitable manner in the various embodiments.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments include been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

I/We claim:

1. A multilayer film, comprising:
a first outer layer and a second outer layer;
a first inner layer positioned between the first outer layer and the second outer layer and adjacent to the first outer layer; and
a second inner layer positioned between the first inner layer and the second outer layer;
wherein the first and second inner layers are formed of a polymer including a glass transition temperature less than or equal to about 150° C. and a melt temperature of at least about 47° C.; and
wherein, upon sealing, the first outer layer, the second outer layer, the first inner layer and the second inner layer provide a sealed multilayer film including a hot tack strength of at least about 0.1N as determined by ASTM F1921 (2012), method B (based on a 15 mm width strip of film).

2. The multilayer film of claim 1, wherein the polymer of at least one of the first and second inner layers comprises a low density polyethylene, linear low density polyethylene, very low density linear polyethylene, polyvinylidene fluoride, ethylene-vinyl acetate, ethylene-vinyl alcohol, polypropylene, polyvinyl chloride, polyamide, polyethylene terephthalate, polybutylene terephthalate, polycarbonate, an ionomer of any of the foregoing, or a combination comprising at least one of the foregoing.

3. The multilayer film of claim 1, wherein the first and second inner layers comprise a low density polyethylene, linear low density polyethylene, very low density linear polyethylene, polyvinylidene fluoride, ethylene-vinyl acetate, or a combination comprising at least one of the foregoing.

4. The multilayer film of claim 1, wherein at least one of the first and second inner layers comprises a Tg less than or equal to about 0° C.

5. The multilayer film of claim 1, wherein at least one of the first and second inner layers comprises a melt temperature of at least about 50° C.

6. The multilayer film of claim 1, wherein at least one of the first and second inner layers comprises a Tg of about 0° C. to about −150° C. and a melt temperature of about 50° C. to about 220° C.

7. The multilayer film of claim 1, wherein at least one of the first and second inner layers comprises a Tg of about −20° C. to about −150° C. and a melt temperature of about 100° C. to about 280° C.

8. The multilayer film of claim 1, wherein at least one of the first and second inner layers comprises a Tg of about −30° C. to about −125° C. and a melt temperature of about 130° C. to about 180° C.

9. The multilayer film of claim 1, wherein the multilayer film comprises a sealed multilayer film including a hot tack strength of at least about 0.15N as determined by ASTM F1921 (2012), method B (based on a 15 mm width strip of film).

10. The multilayer film of claim 9, wherein the multilayer film comprises a sealed multilayer film including a hot tack strength of at least about 0.2N as determined by ASTM F1921 (2012), method B (based on a 15 mm width strip of film).

11. The multilayer film of claim 1, wherein at least one of the first and second outer layers comprises a low density polyethylene, linear low density polyethylene, high density polyethylene, polyvinylidene fluoride, ethylene-vinyl acetate, ethylene-vinyl alcohol, polypropylene, polyvinyl chloride, polyamide, polyethylene terephthalate, polybutylene terephthalate, polycarbonate, an ionomer of any of the foregoing, or a combination comprising at least one of the foregoing.

12. The multilayer film of claim 11, wherein the first and second outer layers comprise a low density polyethylene, high density polyethylene, ethylene-vinyl alcohol, polypropylene, polyvinyl chloride, polyamide, polyethylene terephthalate, polybutylene terephthalate, polycarbonate, or a combination comprising at least one of the foregoing.

13. A package formed of a sealed multilayer film composition, comprising:
a sealed multilayer film configured to hold contents in the package, the sealed multilayer film comprising:
a first outer layer and a second outer layer;
a first inner layer positioned between the first outer layer and the second outer layer and adjacent to the first outer layer; and
a second inner layer positioned between the first inner layer and the second outer layer;
wherein the first and second inner layers are formed of a polymer including a glass transition temperature not greater than about 150° C. and a melt temperature of at least about 47° C.; and
herein the first and second outer layers, the first inner layer and the second inner layer forming the sealed multilayer film has a hot tack strength of at least about 0.1N as determined by ASTM F1921 (2012), method B (based on a 15 mm width strip of film).

14. A method of forming a hot seal on a multilayer film, the method comprising:
introducing a multilayer film to an apparatus including a heating mechanism, wherein the multilayer film comprises
a first outer layer and a second outer layer;
a first inner layer positioned between the first outer layer and the second outer layer and adjacent to the first outer layer; and
a second inner layer positioned between the first inner layer and the second outer layer;
forming a hot seal on the multilayer film with the heating mechanism, the hot seal including a hot tack strength of at least about 0.1N as determined by ASTM F1921 (2012), method B (based on a 15 mm width strip of film); and
cooling the hot sealed multilayer film to form a sealed multilayer film.

15. The method of claim 14, wherein the cooling is provided by a gas jet to cool the hot sealed multilayer film to a desired temperature.

16. The method of claim 15, wherein the gas jet comprises a plurality of gas jets.

17. The method of claim 15, wherein the gas jet is provided within less than about 5 milliseconds.

18. The method of claim 15, wherein the gas jet is arranged to contact the hot sealed multilayer film an angle.

19. The method of claim 18, wherein the angle is 0 to about 60°.

20. A package formed by the method of claim 14.
